(19) United States
(12) Patent Application Publication
(10) Pub. No.: US 2022/0183253 A1
(43) Pub. Date: Jun. 16, 2022

(54) Anti-Cockroach Bowls and Devices

(71) Applicant: UNM Rainforest Innovations, Albuquerque, MN (US)

(72) Inventors: Wilmer L. Sibbitt, Albuquerque, NM (US); John Harrison Sibbitt, Albuquerque, NM (US)

(73) Assignee: UNM Rainforest Innovations, Albuquerque, NM (US)

(21) Appl. No.: 17/551,058

(22) Filed: Dec. 14, 2021

Related U.S. Application Data
(60) Provisional application No. 63/125,221, filed on Dec. 14, 2020.

(51) Int. Cl. A01K 5/01; A01M 29/34

(52) U.S. Cl. CPC A01K 5/0142; A01M 29/34

(57) ABSTRACT

A cockroach resistant container to prevent ambient cockroach intrusion.

### RELATED APPLICATIONS

This application claims priority to U.S. Provisional Application No. 63/125,221, filed on Dec. 14, 2020, which is incorporated herein in its entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Cockroaches commonly infest sewers, buildings, gardens, and any other area where there is warmth and appropriate food. Cockroaches are proven carriers of pathogenic organisms that cause human and animal disease resulting in vector-borne illness and death. Cockroach carcasses and excrement also cause allergic reactions, including dermatitis, anaphylaxis, and asthma. The key to control of cockroaches is to completely block their access to food.

In this regard, one important source of food for cockroaches in and around human habitations is human or pet food that is commonly left in a bowl on a table, the floor of a kitchen, or on the ground outside providing cockroaches easy access to unlimited food. Thus, human or pet food can spawn large colonies of cockroaches both inside and outside of houses and other buildings.

Because ants also commonly infest pet food, there are number of commercial anti-ant pet food bowls that are designed to prevent intrusion by ants. However, these anti-ant products often fail in preventing intrusion of resident cockroaches into pet food.

### BRIEF SUMMARY OF THE INVENTION

In one embodiment, the present invention provides a cockroach resistant container to prevent ambient cockroach intrusion.

In other embodiments, the present invention provides cockroach-resistant bowls and bowl holders and related devices that can resist the invasion of all 6 common species of pest cockroaches, including large American cockroaches, as well as any other crawling insect, such as ants and beetles.

In other embodiments, the present invention provides mechanical structures and designs that do not require moats to be filled with fluids so that the device is simple and functional without barrier fluids and the moat does not fill with dead insect debris and become a source of infection and contamination itself.

In other embodiments, the present invention provides designs that do not require the use of substances that are noxious to cockroaches or could be toxic to pets and humans, such as insecticides, harsh chemicals, or repellants.

In other embodiments, the present invention provides designs that are simple and inexpensive to manufacture and consist of as few parts as possible and thus do not require extensive assembly.

In other embodiments, the present invention uses designs having materials that can be easily cleaned and can be safely placed in a dishwasher where high temperatures can kill any adhering organisms.

In other embodiments, the present invention provides finished product so multiples can be easily stacked and shipped in a small as package as possible.

In other embodiments, the present invention provides modifications to existing anti-ant bowels to convert them to anti-cockroach bowls so that the expense of retooling and production of the anti-cockroach bowls is minimized for the manufacturer.

In other embodiments, the present invention provides a bowl assembly which disposes the food area above the ground or floor. A supporting structure provides a pathway leading from the ground toward the rim of the bowl. A physical obstacle wall extends downwardly and outwardly from the rim and cooperates with the outer side-wall of the bowl to provide multiple physical barriers. The physical dimension of the physical obstacle is proportioned above the ground in particular dimensions so that large cockroaches as well as smaller insects in particular ants cannot access the outer surface of the obstacle and thus cannot enter the container area of the bowl.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1. is a perspective view of a commercial anti-ant bowl based on the U.S. Pat. Nos. 4,905,629 and 4,905,629 to Hand et al.

FIG. 2. is a cross-sectional side view of the anti-ant bowl in FIG. 1.

FIG. 3 is a perspective view of the anti-ant bowl in FIG. 1 and FIG. 2 being overrun by large cockroaches defeating the smaller ant-barrier.

FIG. 4. is a cross-sectional side view of an anti-cockroach bowl created by affixing a non-slip base to an anti-ant bowl so that cockroaches cannot access the outer surface of the insect shield.

FIG. 5 is a chart showing the effect on cockroach intrusion by affixing a base of different heights to an anti-ant bowl so that cockroaches cannot access the outer surface of the insect shield (UNMHSC 2020).

FIG. 6. is a cross-sectional side view of an anti-cockroach bowl created by affixing a non-slip base to an anti-ant bowl and the base is narrow enough to be placed in another bowl so the bowls can be stacked for efficient storage and shipping.

FIG. 7 is a cross-sectional side view of an alternative design of an anti-cockroach bowl created by affixing a non-slip permanent angled base to an anti-ant bowl.

FIG. 8 is a cross-sectional side view of a cockroach-resistant bowl similar to FIGS. 4 and 6 formed by bonding an ant-resistant bowl to an alternative platform design consisting of a bonded cylindrical platform.

FIG. 9 is a cross-sectional side view of an ant-resistant bowl similar to FIG. 8 reversibly converted to a cockroach-resistant bowl by placing it in a formed bowl holder.

FIG. 10 is a cross-sectional side view of a cockroach-resistant bowl similar to FIGS. 4-9 formed by bonding or placing an ant-resistant bowl to an alternative legged platform design.

FIG. 11 is a cross-sectional side view of a cockroach-resistant bowl formed by bonding an ant-resistant bowl to a platform consisting of an inverted bowl or bowl-like structure to raise the shield to block larger insects.

FIG. 12 is a perspective view of a cockroach-resistant bowl in FIG. 11 formed by bonding an ant-resistant bowl to a platform consisting of an inverted bowl or bowl-like structure to raise the shield to block larger insects.

FIG. 13 is a cross-sectional side view of a dual-size cockroach-resistant bowl with the smaller bowl in the functional position formed by bonding an ant-resistant bowl to a platform consisting of an inverted anti-ant bowl to raise the shield to block larger insects.

FIG. 14 is a cross-sectional side view of a dual-size cockroach-resistant bowl with the larger bowl in the functional position formed by bonding an ant-resistant bowl to a platform consisting of an inverted anti-ant bowl to raise the shield to block larger insects.

FIG. 15 is a cross-sectional side view of an anti-cockroach bowl created by making the bowl deeper to raise the anti-insect shield to block cockroaches.

FIG. 16 is a perspective view of an anti-cockroach bowl created by making the bowl deeper to raise the anti-insect shield to block cockroaches.

FIG. 17 is a cross-sectional view of an anti-cockroach bowl created by making the bowl deeper to raise the anti-insect shield to block cockroaches and tapering the sides so that the bowls can be stacked for easy shipping.

FIG. 18 is a cross-sectional view of an anti-cockroach bowl created by making the bowl deeper to raise the anti-insect shield to block cockroaches with curved the sides so that the bowls can be stacked for easy shipping.

FIG. 19 is a perspective view of the bowl-holder designed to accept cockroach-resistant bowls.

FIG. 20 is a cross-sectional side view of bowl holder designed to accept the cockroach resistant bowls with the bowls in place.

FIG. 21 is a perspective view of bowl holder designed to accept cockroach-resistant bowls with the bowls in place.

FIG. 22 is a perspective view of a bowl holder with the cockroach feature as part of the bowl holder designed to accept conventional bowls.

FIG. 23 is a cross-sectional side view of cockroach-resistant bowl holder designed to accept conventional bowls with the bowls in place.

FIG. 24 is a cross-sectional side view of cockroach-resistant bowl holder designed to accept conventional bowls as in FIG. 23 with the conventional bowls in place.

FIG. 25 is a cross-sectional side view of cockroach-resistant bowl holder modified to become a cockroach-resistant table or surface.

FIG. 26 is a cross-sectional side view of cockroach-resistant bowl holder (A) designed to accept as single conventional bowl (B).

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

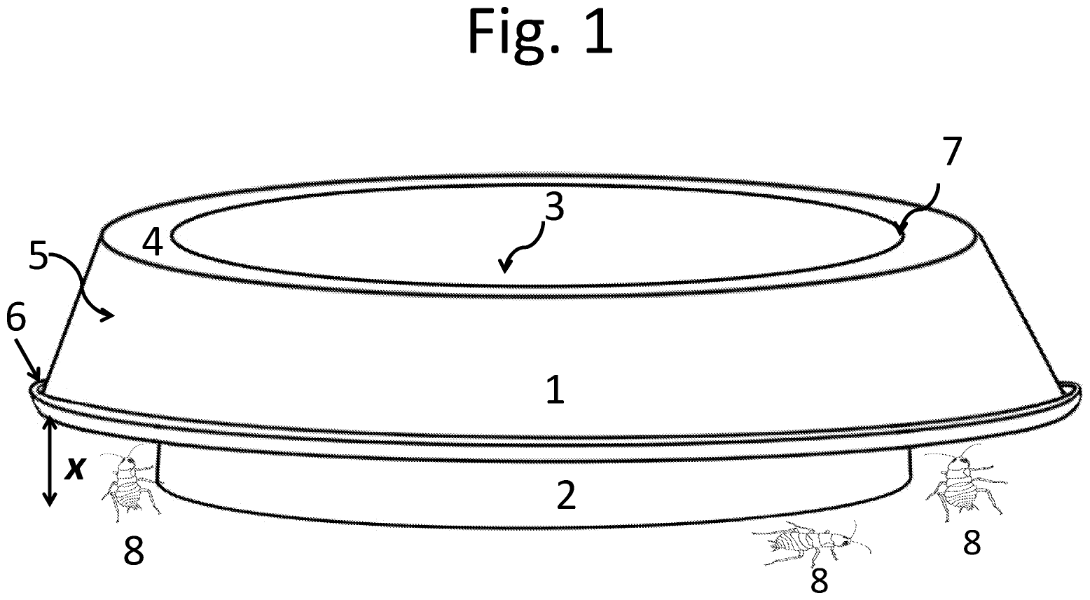

FIG. 1 represents a perspective view of a typical prior art anti-ant device comprising an animal feeding dish 1 including a generally circular shaped bowl assembly 7 having a disposed above the ground or floor surface by a base support member 2. The base support member 2 is generally cylindrical in shape and supports the bowl food holding area 3 above the ground or floor. Generally, a rim 4 extends horizontally to anti-ant shield or skirt 5 with a lip 6 that is a distance “x” above the ground so that ants 8 cannot reach the lip 6 or access the external surface of the anti-ant shield 5 and thus cannot access the extension 4 or the interior of the bowl 3.

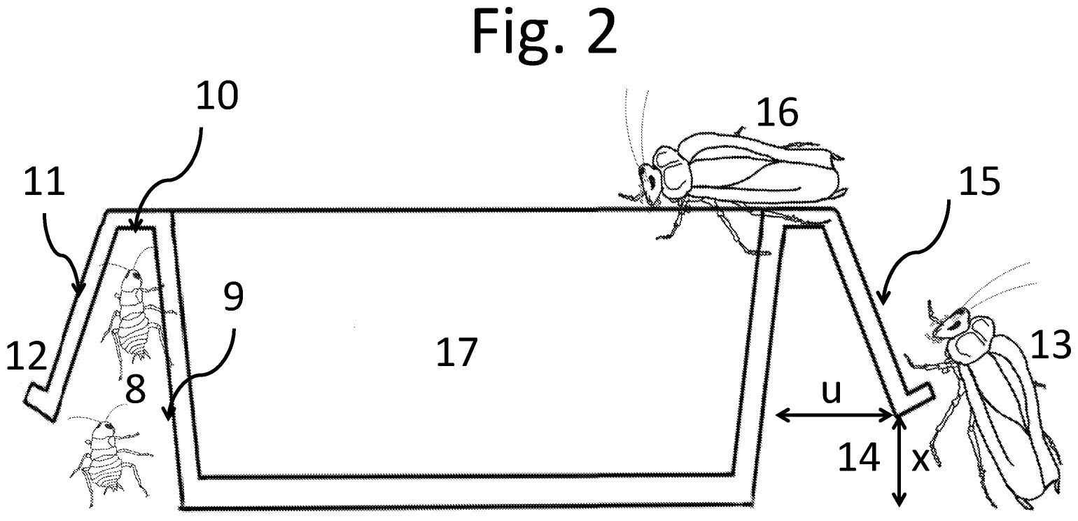

FIG. 2 is a cross sectional view of a prior art commercial anti-ant device as in FIG. 1 ants 8 can access the interior dimension of the shield “u” and crawl up the base support 9 but are blocked from entry by the internal surface of rim 10 and cannot access the external surface of the anti-ant shield 11 and lip 12. However, large cockroaches 13 who with their legs can exceed the distance “x” 14 can access both the external surface of the lip and anti-ant shield, and can scale the external surface of the anti-ant shield 15 and then the cockroach 16 can access the interior of the bowl 17.

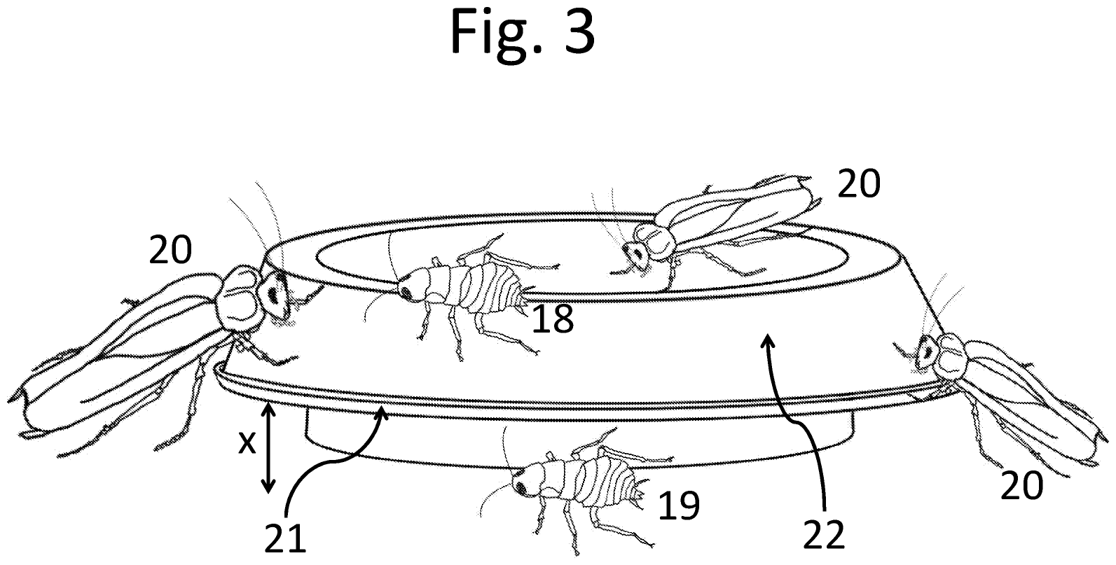

Referring to FIG. 3, representing a perspective view of a typical anti-ant device as in U.S. Pat. Nos. 4,905,629 and 4,905,629 to Hand et al any cockroach either female 18 or juvenile 19 or male 20 that can defeat the distance “x” of the lip 21 or anti-cockroach flange 22 can access and contaminate the interior of the bowl.

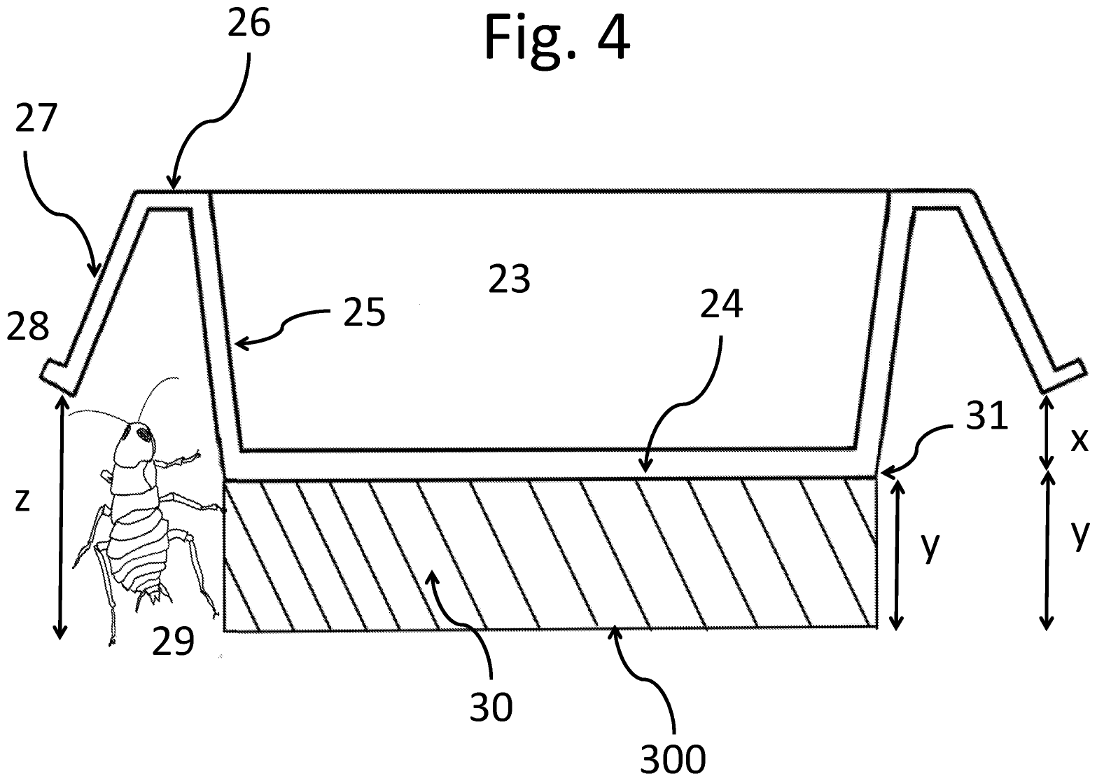

FIG. 4 illustrates an embodiment of the present invention. The embodiment consists of an internal container area 23, a circular plate bottom surface 24, a generally cylindrical sidewall base support 25, a rim 26, an anti-ant shield 27, and a lip 28. The surface of the lip 28 is vertically raised above the ground a distance “z” to exceed the reach of the cockroach 29. The dimension “z” depends on the size and athleticism of the cockroach 29.

The distance “z” may be the vertical distance between lip 28 and bottom surface 24 when base 30 is not used. When base 30 having bottom edge 300 is used, the distance “z” may be the vertical distance between lip 28 and bottom edge 300.

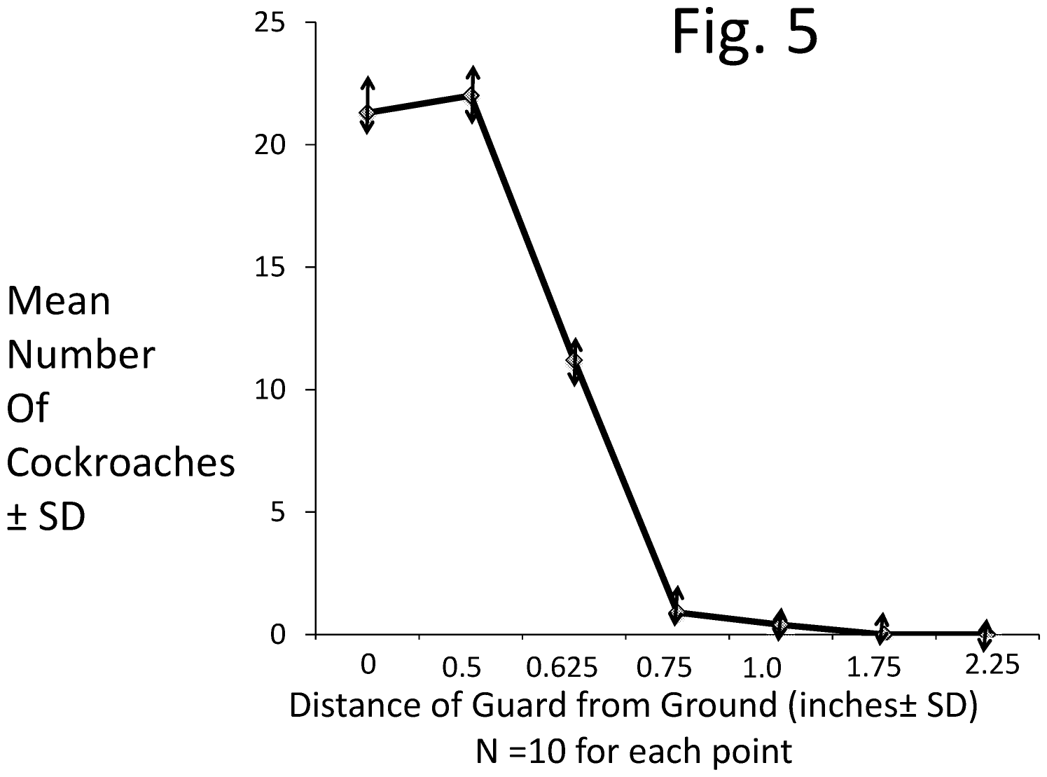

Referring to FIG. 5 it was determined the optimal distance “z” as shown in FIG. 4. by performing a series of real-life experiments of an anti-ant bowel with an anti-ant lip and flange as in FIGS. 1-3 and added a base of dimension “y” as shown in FIG. 4 (UNMHSC 2020). FIG. 5 demonstrates the mean number of cockroaches after a 3-hour period that were able to overcome the anti-ant bowl versus the distance “z”. As can be seen, the number of cockroaches began declining when z=0.625 inch (15.9 mm) and declined to only a few very large cockroaches at z=1.0 inch (25.4 mm). The cockroaches that were able to overcome the z=1.0 inch (25.4 mm) were the larger American cockroaches that can be up to 3 inches in length. However, at z=1.75 inches (44.5 mm) and 2.25 inches (57.2 mm) no cockroaches penetrated the modified bowl. Thus, to defeat the majority of cockroaches (Oriental, German, Turkestan, and most Australian cockroaches) should “z” be at least 1 inch (25.4 mm) or greater and to defeat American cockroaches preferably greater than 1 inch (>25.4 mm) with 1.75 inches (44.5 mm) and 2.25 inches (57.2 mm) defeating all tested cockroaches.

In yet other embodiments, a base of various heights was affixed to the bottom of an anti-ant bowl to increase the distance of the anti-ant shield from the native height “x” to the hypothesized cockroach resistant height “z”. The effects of z=0, 12.7, 15.9, 19.1, 25.4, 44.5, and 57.2 mm were studied. 118.3 cc (4 oz) of dry cat food was used as cockroach bait. The modified anti-ant bowls were placed in a high-intensity cockroach environment during summer nights where the temperatures varied between 23.9-29.4 degrees Celsius for 3 hours and then cockroach counts were performed. Ten runs at each height z were performed.

Results:

Mean numbers of infesting cockroaches±SD at each height z were 21.3±2.9 at 0 mm, 22.0±2.9 at 12.7 mm, 11.2±2.6 at 15.9 mm, 0.9±0.8 at 19.1 mm, 0.4±0.5 at 25.4 mm, 0±0 at 44.5 mm, and 0±0 at 57.2 mm (p<0.001 with z≥15.9 mm for all). The number of cockroaches began declining when z=15.9 mm and declined to only a few very large cockroaches at z=25.4 mm. The cockroaches that were able to overcome the z=25.4 mm were the larger American cockroaches that can exceed 76.2 mm (3 inch) in length. However, at z=44.5 mm and 57.2 mm no cockroaches penetrated the modified bowl.

Thus, to defeat the majority of species of cockroaches the anti-insect shield should be at a height of at least 25.4 mm and to defeat the larger American cockroaches preferably greater than 25.4 mm with 44.5 mm and 57.2 mm defeating all tested cockroaches

Methods:

A number of commercial anti-ant food bowls have a protruding ant flange, skirt, or shield above the ground that is situated so insects, primarily ants, cannot access the outside surface of the shield because the shield is above the ground (7-9). FIG. 1 represents a perspective view of such a typical anti-ant device as described comprising an animal feeding dish including a generally circular shaped bowl assembly having a shield disposed above the ground or floor surface by a base support member. The base support member is generally cylindrical in shape and supports the bowl food holding area above the ground or floor. Generally a rim extends horizontally to anti-ant shield that is a distance “x” above the ground so that ants cannot reach or access the external surface of the anti-ant shield and thus cannot access the interior of the bowl.

The designs of these commercial anti-ant bowls as in FIG. 1, however, do not stop flying insects or large insects like certain species of cockroaches that can typically be 25.4 mm (1 inch) up to 76.2 mm (3 inches long) (2,10-12). FIG. 2 shows a common American cockroach that can exceed 80 mm (3.14 inch) in length. Typically, commercial anti-ant bowls do not prevent intrusion of cockroaches. It is believed that cockroaches defeat the dimensions of the ant shield by jumping or by extending from the ground onto the external facing surface of the shield and thus scale into the bowl or scale the wall of the bowl and then reach outward to the edge of the shield and climb into the bowl (FIG. 3). Thus, it is believed that these anti-ant products fail preventing intrusion of cockroaches because the larger size of cockroaches relative to ants allow these larger insects to access the exterior of the anti-ant shield, defeating this barrier, and gaining access to the pet food bowl (FIG. 4).

A 236.6 cc (8 oz) anti-ant bowl (Anti-Ant Stainless Steel Non Skid Pet Bowl for Dog or Cat—8 oz—1 cup, SKU 799665921910, Item Number 92191, Iconic Pet, LLC, 611 South Ave, Garwood, N.J. 07027. Website: www.iconicpet.com) was studied to determine how an anti-ant bowl could be modified to become an anti-cockroach bowl.

An anti-ant bowl may become an anti-cockroach bowl by affixing a base of a height of y to the circular plate bottom surface and thus increase the distance of the lip and shield from the native anti-ant height x to the cockroach resistant height z that would exceed the ability of the cockroach to access the outside surface of the shield (FIG. 5). A base was added and subtracted through graduations so that the effects of z=0, 12.7, 15.85, 19.05, 25.4, 44.45, and 57.15 mm (0, 0.5, 0.624, 0.75, 1.0, 1.75, and 2.25 inches) were studied. In these experiments 118.3 cc (4 oz) of dry cat food (Crave with Protein from Salmon & Ocean Fish Adult Grain-Free Dry Cat Food, Crave Pet Foods, Mars Petcare US Company, Franklin, Tenn., USA, Website: www.cravepetfoods.com) was used as cockroach bait. The modified dishes were placed in a high-intensity cockroach environment during the night during summer where the temperatures varied between 23.9-29.4 degrees Celsius (75-87 degrees Fahrenheit) for 3 hours and then cockroach counts were performed (FIG. 4). Ten runs at each height z were performed. After each experiment the cockroaches were not destroyed, but rather released back alive into the high intensity cockroach environment. Summary data were expressed as mean±standard deviation and means at different heights z were compared with the student t-test with corrections for multiple comparisons.

Results

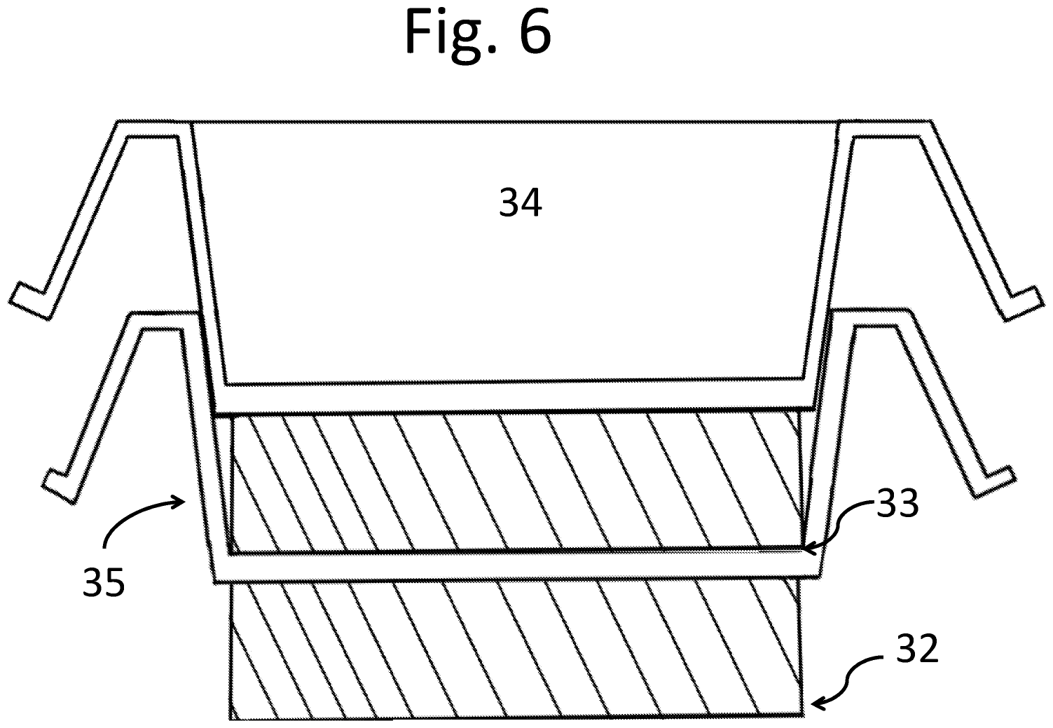

Table 1 and FIG. 6 demonstrate the mean number of cockroaches after a 3-hour period that were able to overcome the anti-ant shield and infest the bowl versus the distance z as defined in FIG. 5. Mean numbers of infesting cockroaches±SD at each height z were 21.3±2.9 at 0 mm, 22.0±2.9 at 12.7 mm, 11.2±2.6 at 15.9 mm, 0.9±0.8 at 19.1 mm, 0.4±0.5 at 25.4 mm, 0±0 at 44.5 mm, and 0±0 at 57.2 mm (p<0.001 with z≥15.9 mm for all) (Table 1).

TABLE 1
Number of Cockroaches versus Height of Anti-Ant Shield

| | | | | | | | |
|---|---|---|---|---|---|---|---|
| Height of shield | 0 | 12.7 | 15.9 | 19.1 | 25.4 | 44.5 | 57.2 |
| (mm) | | | | | | | |
| Number of runs | 10 | 10 | 10 | 10 | 10 | 10 | 10 |
| Meant number | 21.3 | 22 | 11.2 | 0.9 | 0.4 | 0 | 0 |
| of cockroaches | | | | | | | |
| Standard | 2.9 | 2.9 | 2.6 | 0.77 | 0.5 | 0 | 0 |
| Deviation | | | | | | | |
| 95% CI of | 3.4 < 0.7 < 2.0 | NA | 13 < 11 < 8 | 23 < 21 < 19 | 24 < 22 < 19 | 24 < 22 < 20 | 24 < 22 < 20 |
| difference | | | | | | | |
| (Wald): | | | | | | | |
| *P value | 0.6 | NA | <0.001 | <0.001 | <0.001 | <0.001 | <0.001 |

CI = confidence interval
*P values were determined with the t-test using the cockroach numbers at the native height of the bowl at 12.7 mm as a comparator. Corrections were made for multiple comparisons.

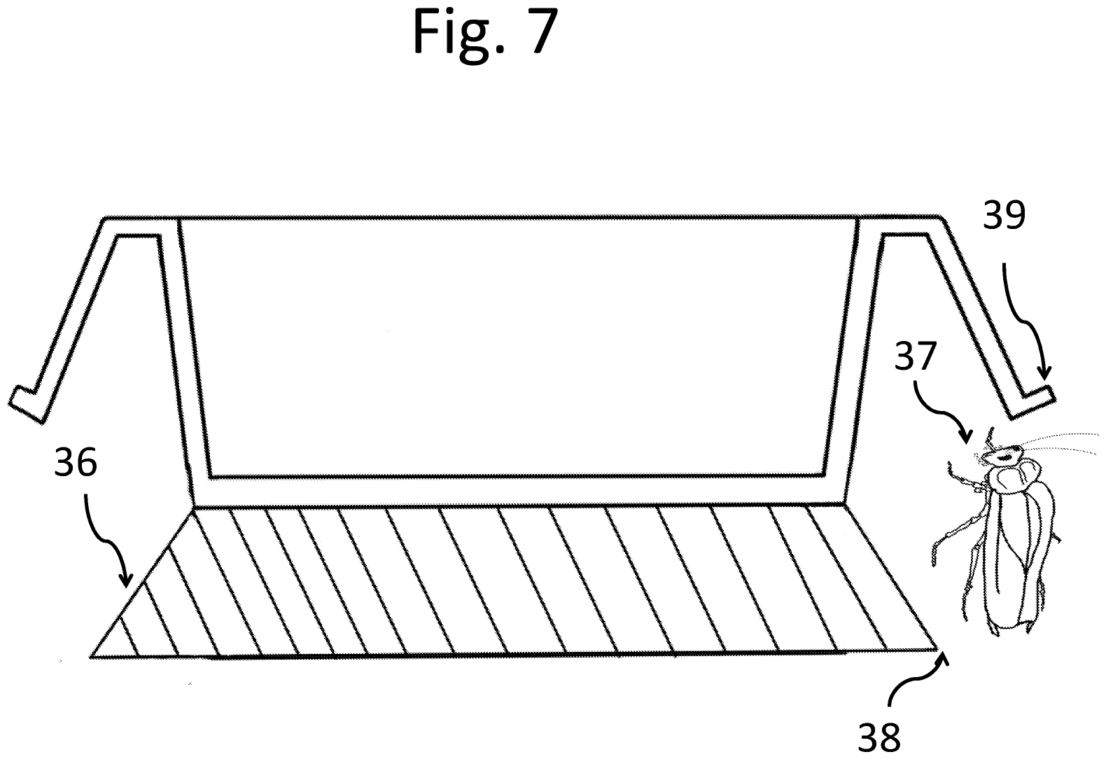

As can be seen, the number of cockroaches began declining when z=15.9 mm and declined to only a few very large cockroaches at z=25.4 mm. The cockroaches that were able to overcome the z=25.4 mm were the larger American cockroaches that can be up to 76.2 mm (3 inches) in length. However, at z=44.5 mm and 57.2 mm no cockroaches penetrated the modified bowl (FIG. 7).

Thus, to defeat the majority of species of cockroaches the anti-ant shield should be at a height of at least 25.4 mm and to defeat the larger American cockroaches preferably greater than 25.4 mm with 44.5 mm and 57.2 mm defeating all tested cockroaches.

Discussion

Because cockroaches feed on human and animal feces these insects commonly spread bacteria, viruses, and parasites known to cause both animal and human disease. Cockroaches are proven carriers of pathogenic organisms including staphylococcus, enteric organisms, streptococcus, viruses and parasites—organisms that may cause life-threatening diarrhea, dysentery, cholera, leprosy, plague, typhoid fever and viral diseases such as poliomyelitis resulting in severe illness or death. In addition cockroaches carry the invertebrate parasites, including eggs and cysts of parasitic worms and organisms that infest both humans and pets. Cockroach carcasses and excrement may also cause severe allergic reactions, including dermatitis, itching, swelling of the eyelids, anaphylaxis, and allergic asthma, resulting in increased costs, medical care, and in some cases death.

Cockroaches are insects from the size of large ants 2-3 mm (0.08-to 0.12 inch) to the size of large beetles over 80 mm (3.14 inch) in length (FIGS. 2 and 4). Of over 3500 identified cockroach species only a few have adapted to living in buildings in close association with people and these cockroaches have become serious pests. Cockroaches eat crumbs, pet food, cookies on a plate, human and animal feces and even human skin and nail clippings.

The key to control of cockroaches is to remove their access to food. In this regard, one very important source of food for cockroaches in and around human habitations is human or pet food, especially dog and cat food that is commonly left in a bowl on the ground outside or on floor of a kitchen for the pets where the cockroaches can and do easily access the pet food (FIG. 4). Thus, pet food can spawn large colonies of cockroaches both inside and outside of houses. The cockroaches contaminate the pet food with their feces and secretions and thus transmit bacterial, parasitic, and viral diseases to both the pets and to the pet's human owners. Because of the excess of food, the cockroaches are able to expand their colonies and cockroach numbers, causing an even greater infestation locally and the cockroach colonies may expand both inside and outside the house and then invade adjoining properties.

Because of the magnitude of the problem of crawling insects, in particular ants, infesting dog and cat food bowls, there are many patents and products relating to insect-proof pet bowls. A number of different mechanisms are used to prevent intrusion of insects, particularly ants, into the food bowl. One solution to preventing ingress of ants has been the use of a barrier consisting of a moat that is filled with water, insecticide, or other form of insect repellant. A problem with these moats or traps is that they must be filled regularly with water or liquid to function—once they dry out, they no longer repel insects. Further, the moats typically catch and drown many of the crawling insects, so eventually the traps fill with the rotting carcasses of insects that must be periodically cleaned from the moats. Further, if the moat is also used as a drinking station the drinking water becomes contaminated with all the filth, bacteria, viruses, and parasite eggs that insects and cockroaches carry. Further, certain cockroaches easily survive in watery environments like sewers and thus are semi-aquatic and can easily defeat liquid barriers.

Another solution to prevent ingress of insects is the use of noxious substances such as caustic chemicals, insecticides, and insect repellants. A problem of using noxious substances is that the pet or human may be injured, killed, or made sick by the caustic chemical, insecticides, and repellants. Further, the noxious substance must be regularly replenished.

Another solution is a mechanical barrier on the dish or bowl that prevents ingress of crawling insects consisting of a protruding anti-ant flange, skirt, or shield that is situated a certain distance above the ground so that ants cannot access the outside surface of the shield and thus cannot enter the bowl (FIG. 1). This basic design is presently used in many contemporary anti-ant pet feeders. This design, however, does not stop flying insects or, as the present research demonstrates, large insects like certain species of cockroaches that can defeat the dimensions of the ant shield by jumping or by extending from the ground onto the external facing surface of the shield and thus scale into the bowl or scale the wall of the bowl and then reach outward to the edge of the shield and climb into the bowl (FIGS. 2 and 3). Typical commercial “ant-free” products based on this design that were tested in the present research did not prevent cockroaches from accessing the interior of the bowl (FIG. 4). The results of the present research demonstrate that many cockroaches can still access the bowl at 19 mm (0.75 inch) and greater off of the ground (FIGS. 4 and 6). It is believed that the failure of these anti-insect designs that are effective for ants, but fail for cockroaches is largely due to the larger dimensions and athleticism of cockroaches that defeat these mechanical barriers (FIGS. 2,3,4,6, and 7).

The most common cockroach species considered pests in human habitations are as follows:

Periplaneta americana, the American cockroach, the adult forms of which is 35-40 mm (1.4-1.6 inches), but may exceed 51 mm (2 inches) in length up to 80 mm (3.14 inch) in length (FIG. 2). The American cockroach is originally from Africa, but is a widespread pest throughout North America and the world in buildings and sewers.

Periplaneta australasiae, the Australian cockroach, which is similar to the American cockroach and is 31-37 mm (1.2-1.5 inch) long.

Blatta orientalis, the Oriental or Chinese cockroach, found mainly in cool temperate regions. It is blackish and 20-27 mm (0.8-1.1 inch) long.

Supella longipalpa, the brown-banded cockroach, 10-14 (0.4-0.6 inch) mm long and has yellow and brown bands.

Blattella germanica, the German cockroach, found in most parts of the world. It is light yellowish brown and 10-15 mm (0.4-0.6 inch) in length.

Shelfordella lateralis (Blattella lateralis), the Turkestan cockroach the females are 20-36 mm (0.8-1.4 inch) in length. It is light yellowish brown. The males are 10-15 mm (0.4-0.6 inch) in length.

As can be seen from the above, 4 of the 6 common pet cockroach species (the American cockroach, the Australian cockroach, the Oriental cockroach, and the Turkestan cockroach) commonly exceed 19 mm (0.75 inch). Indeed in the present research anti-ant products based on these designs failed when tested against cockroaches (FIGS. 4 and 6, Table 1). Thus, to be able to defeat the American, Australian, Oriental, and Turkestan cockroaches the barrier must be able to exclude cockroaches much larger than 19 mm (0.75 inch).

An anti-ant bowl may be modified to become an anti-cockroach bowl by affixing a base to the bowl and thus increase the distance of the anti-ant shield from the native anti-ant height to a cockroach-resistant height that would exceed the ability of the cockroach to access the outside surface of the shield (FIG. 5). As can be seen in FIG. 6, the number of cockroaches intruding began declining when the height of the anti-ant shield was 15.9 mm (0.625 inch) and declined to only a few very large cockroaches when the height of the shield was 25.4 mm (1 inch). The cockroaches that were able to overcome 25.4 mm (1 inch) were mostly the larger American cockroaches that can be up to 76.2 mm (3 inches) in length (FIG. 2) (10-12). However, at a height of 44.5 mm (1.75 inches) and 57.2 mm (2.25 inches) no cockroaches penetrated the modified bowl (FIGS. 6 and 7). Thus, to defeat the majority of small to medium cockroaches the shield should be at least 25.4 mm (1 inch) or greater and to defeat the larger American cockroaches preferably greater than 25.4 mm (1 inch) with 44.5 mm (1.75 inches) and 57.2 mm (2.25 inches) defeating all tested cockroaches (FIGS. 6 and 7, Table 1). Further, the anti-cockroach modifications do not interfere with the anti-ant properties of the bowl.

The reason the tested anti-ant and anti-cockroach shields so effectively interferes with the movement of insects into the bowl is uncertain. Clearly all of the insects have the physical ability to walk on surfaces of the bowl upside down where they could ambulate up the side of the bowl, walk upside down on the inferior surface of the shield away from the center of the bowl, wrap themselves around the lip, and then access the superior surface of the shield and walk into the bowl (FIGS. 1 and 3). However, the insects tested in the current experiments did not do this. It has been speculated that the orientation of an insect shield creates a mechanical barrier that disorients the insect's foraging activity, increases the insect area restricted search time making defeating the shield unacceptably time-consuming, disrupts communication between insects and thus cooperative foraging, interferes with trail pheromones of insects that successfully reached the bowl area, and attenuates the polarized and unpolarized ultraviolet light used for navigation and orientation by insects thus defeating their access to the bowl. However, it has been determined that the anti-ant shield is also highly effective as an anti-cockroach shield when properly elevated to account for the larger cockroach size (FIGS. 4-7, Table 1).

The geographical ranges of pest cockroaches include most of the world and are especially concentrated in urban areas. Pest cockroaches can be found in tropical Lagos, Nigeria as well as in Moscow, Russia both typically infesting buildings and sewer systems. This simple inexpensive mechanical anti-cockroach technology should help prevent pet feeders from being a food source for cockroach colonies while still maintaining anti-ant properties and thus decrease infestations and potential transmission of pathogenic organisms to both pets and their human owners.

### Alternate Embodiments

As shown in FIG. 4 the base 30 could be solid and roughly cylindrical and flush with the outside wall 31 of the bowl. However, this configuration may interfere with stacking for shipping. Alternatively, as shown in FIG. 6 the base 32 could be lesser in diameter or tapered so that it could fit into the inner surface of the bowl 33 so the upper bowl 34 can be stacked in the lower bowl 35, a property that is advantageous for shipping.

However, in some situations it is advantageous to have a broader base 36 as shown in FIG. 7 so the bowel is more stable as long cockroaches 37 cannot use the inferior edge of the base 38 to access the superior surface or lip of the cockroach guard 39.

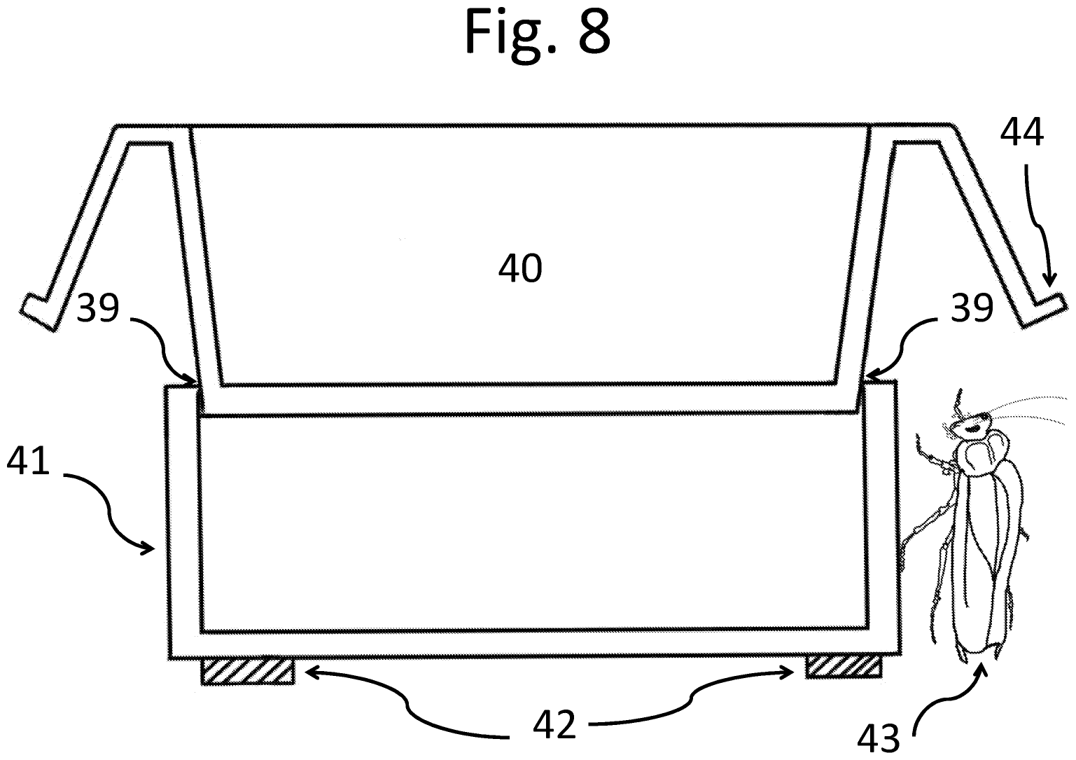

Other base configurations could be used to convert an anti-ant bowl to an anti-cockroach bowl. FIG. 8 is an embodiment where leading edge 39 of an anti-ant bowl 41 is affixed or bonded to a cylindrical open or closed base 41 of metal or plastic with non-slip material 42 on the bottom to become an anti-cockroach bowl so the cockroach 43 cannot access the superior edge of the cockroach guard 44.

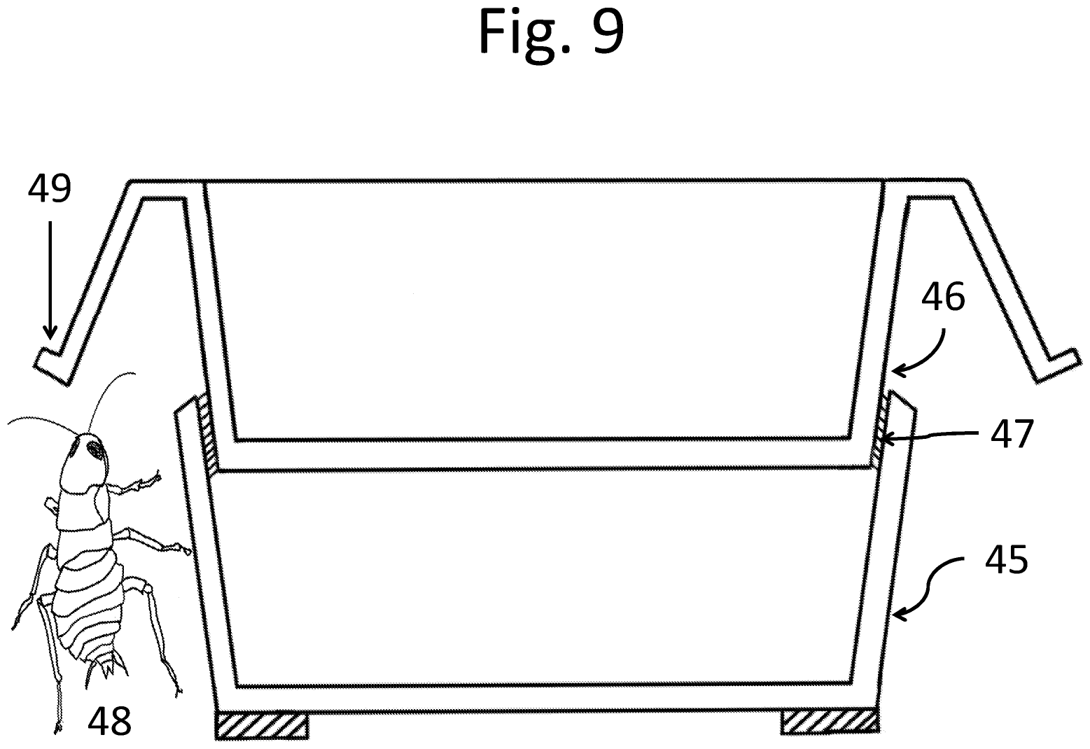

FIG. 9 is a similar embodiment as FIG. 8 except that the base 45 has tapered or shaped walls that can reversibly accommodate and hold the anti-ant bowel 46 and may have a reversible contact area 47 made of plastic, polymer, cork or rubber to reversibly bond the anti-ant bowel 46 so that cockroaches 48 cannot access the outer surface of the insect guard 49 to convert the anti-ant bowl to an anti-cockroach bowl.

The anti-slip surface of the base could be an anti-slip coating or layer or base composed of stainless steel, metal, plastic, rubber, polymer, ceramic, cork, or other substance.

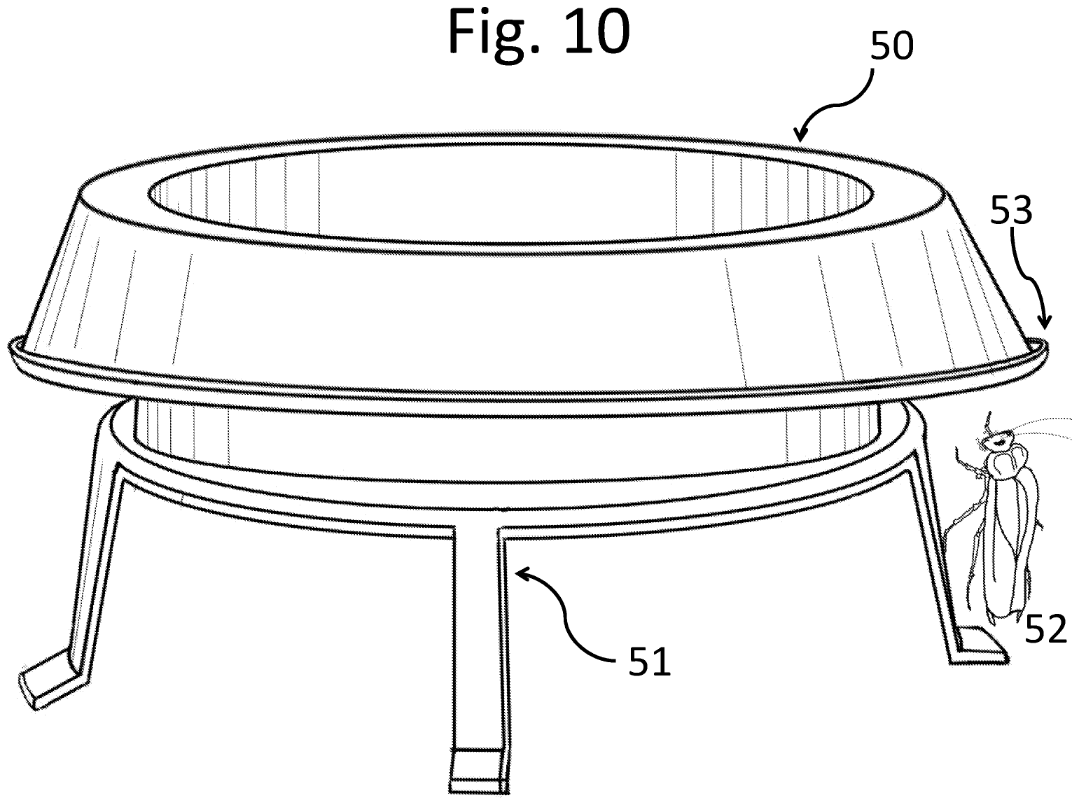

The base to convert an anti-ant bowl to an anti-cockroach bowl could also be of other configurations. FIG. 10 is a configuration where the anti-ant bowl 50 is bonded to a legged base 51 to prevent cockroaches 52 from accessing the external surface of the ant-guard 53.

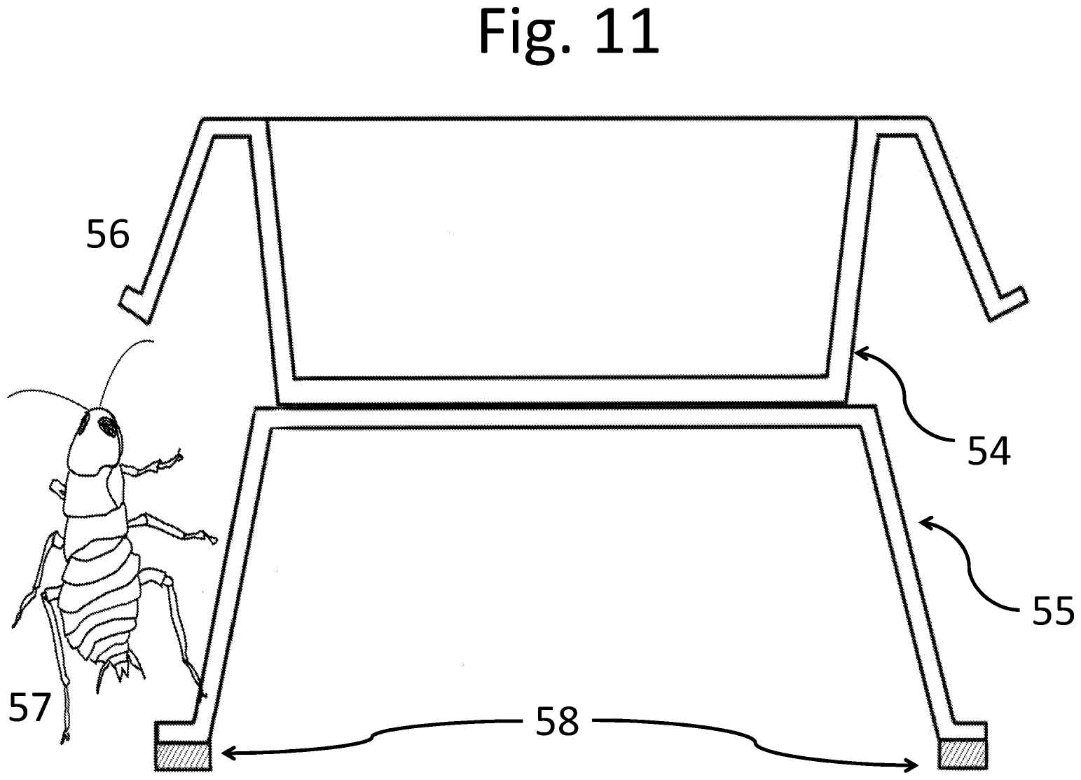

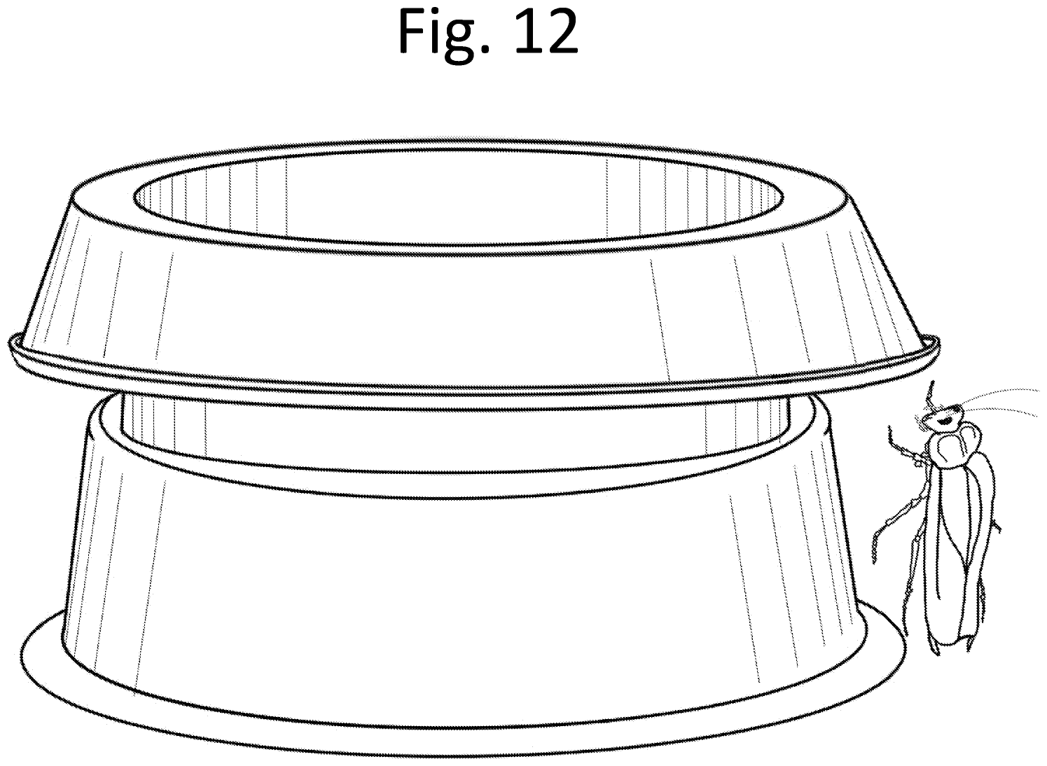

FIG. 11 is a cross sectional view of a particularly stable configuration consisting of an anti-ant bowl 54 bonded to an inverted conventional bowl 55 that could be stainless steel or plastic or other material again raising the guard 56 so cockroaches 57 cannot access the guard 56. Anti-slip material 58 on the inferior surface of the base 55 can further stabilize the anti-cockroach bowl. FIG. 12 is a perspective view of the same configuration.

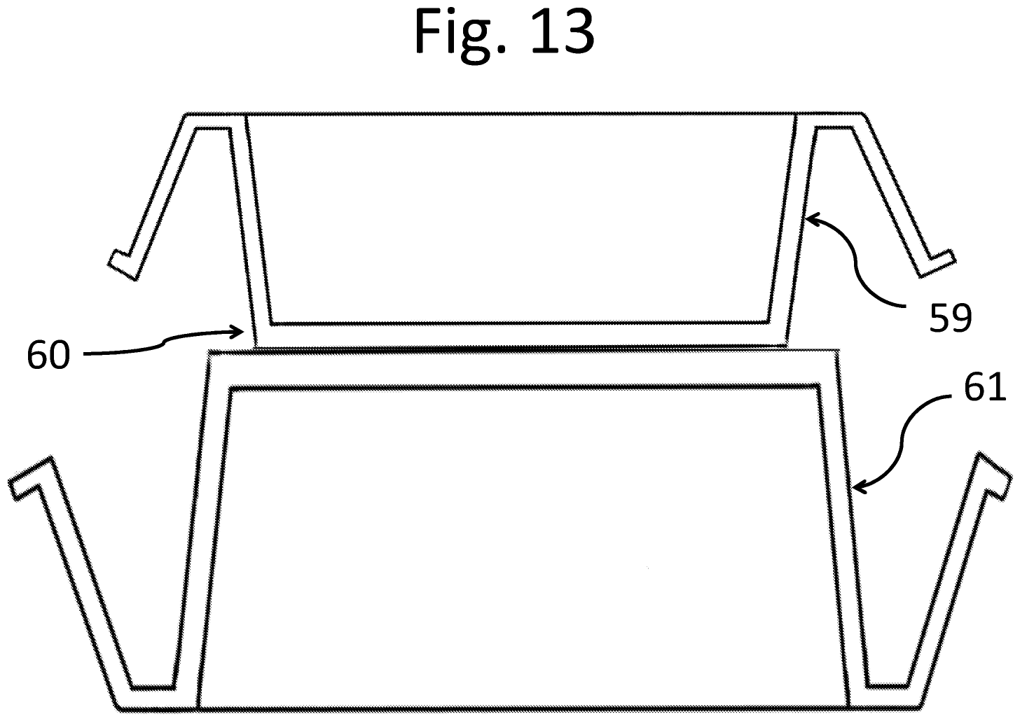

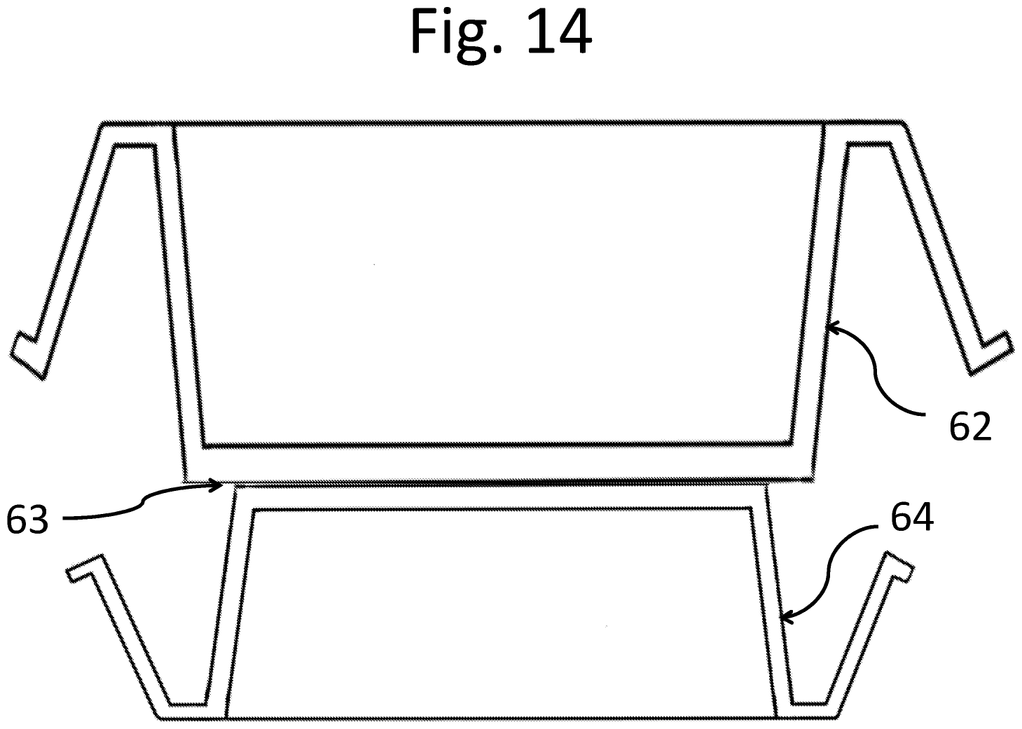

FIG. 13 is a cross sectional view of an embodiment similar to those of FIGS. 11 and 12 but in this case consisting of a small anti-ant bowl 59 bonded 60 to a base consisting of an inverted bowel 61, but in this case the inverted bowl 61 is a large anti-ant bowl of the same design, resulting a cockroach resistant bowl that can function as a cockroach resistant small bowl or a large bowel depending what side facing up. FIG. 14 is the same embodiment inverted showing the larger bowl 62 on top and bonded 63 to the smaller bowl 64 on the bottom so that the larger bowl 62 functions as a large cockroach resistant bowl and the smaller bowl 64 functions as the base.

It is anticipated the base in the above embodiments could be produced as a kit to convert an anti-ant bowl to an anti-cockroach bowl where the kit would include a base that is compatible with the bottom surface of the anti-ant bowl and an attachment means that could be reversible or irreversible including glue, caulking, cement, adhesive surfaces, and interdigitating mechanical attachments.

The previous embodiments of this invention were intended to post-production modify existing anti-ant bowls to transform them into anti-cockroach bowls. However, it might be useful in many instances to produce native bowls that are resistant to cockroaches rather than post-production modify anti-ant bowls to be anti-cockroach bowls.

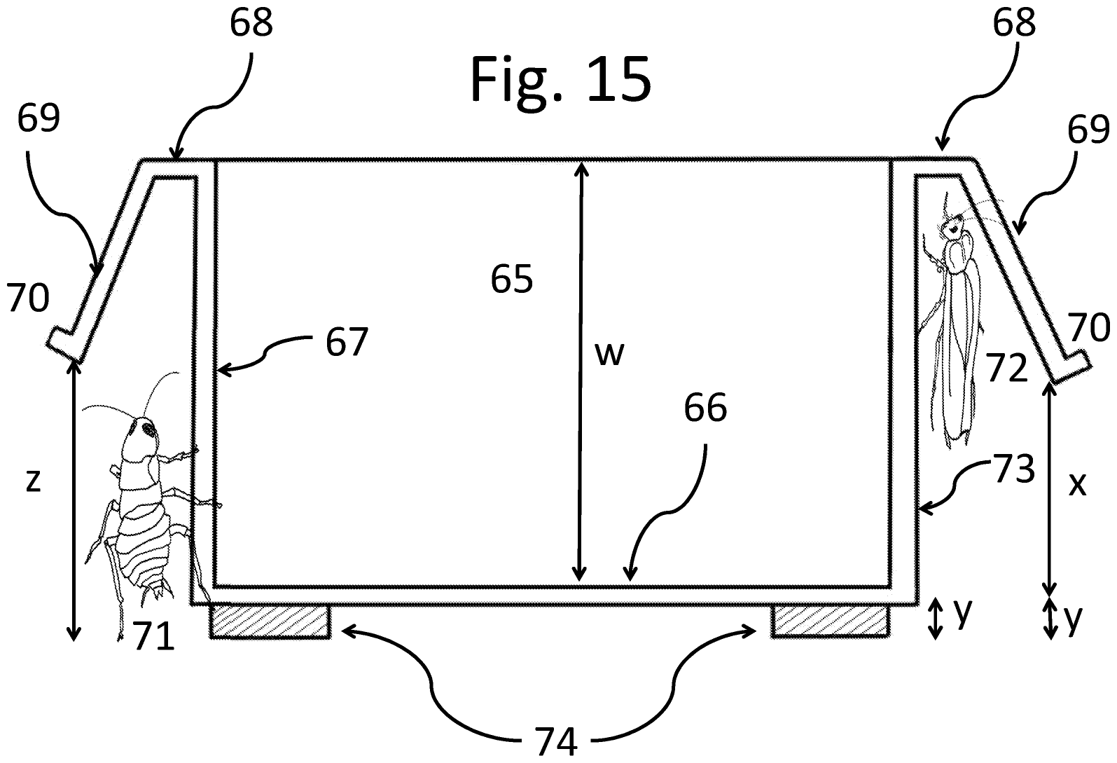

Referring to FIG. 15 cross-sectionally representing the elements of a specifically designed anti-cockroach bowl rather than an anti-ant bowl as in FIGS. 1-3 or an anti-ant bowl modified to be an anti-cockroach bowl as in FIG. 4 and FIGS. 6-14. The device as shown in FIG. 15 consists of an internal container area 65 with a depth w, a circular plate bottom surface 66, a generally cylindrical sidewall base support 67, a rim 68, an anti-cockroach flange 69, and a lip 70. The surface of the lip 70 and flange 71 need to be above the ground a distance “z” to exceed the reach of the cockroach 71. The dimension “z” depends on the size and athleticism of the cockroach 71. As shown in FIG. 5 the cockroach resistant height “z” exceeds the ability of the cockroach to access the outside surface of 69 and flange 70, and this distance must equal to 1 inch (25.4 mm) or greater to defeat larger American cockroaches, but must be at least 0.625 inch (15.9 mm) to begin to defeat smaller cockroaches according to our experimentation (FIG. 5). Basically the depth w of the bowl 65 is increased to simultaneous increase the critical cockroach resistance distance z rather than raising z by using a base as in as in FIG. 4 and FIGS. 6-14. Similar to the embodiments shown FIG. 4 and FIGS. 6-17, in FIG. 15 if the cockroach 72 climbs the outer wall 73 of the bowl the cockroach 72 is blocked from entry by lower surface of the rim 68 and the inner facing surface flange 69 thus the cockroach 72 cannot access the lip 70. These bowls could also have a non-slip surface 74 of height y so that the distance from the flange to the superior surface of 74 is x so that x+y equals or is greater than the cockroach resistant distance z.

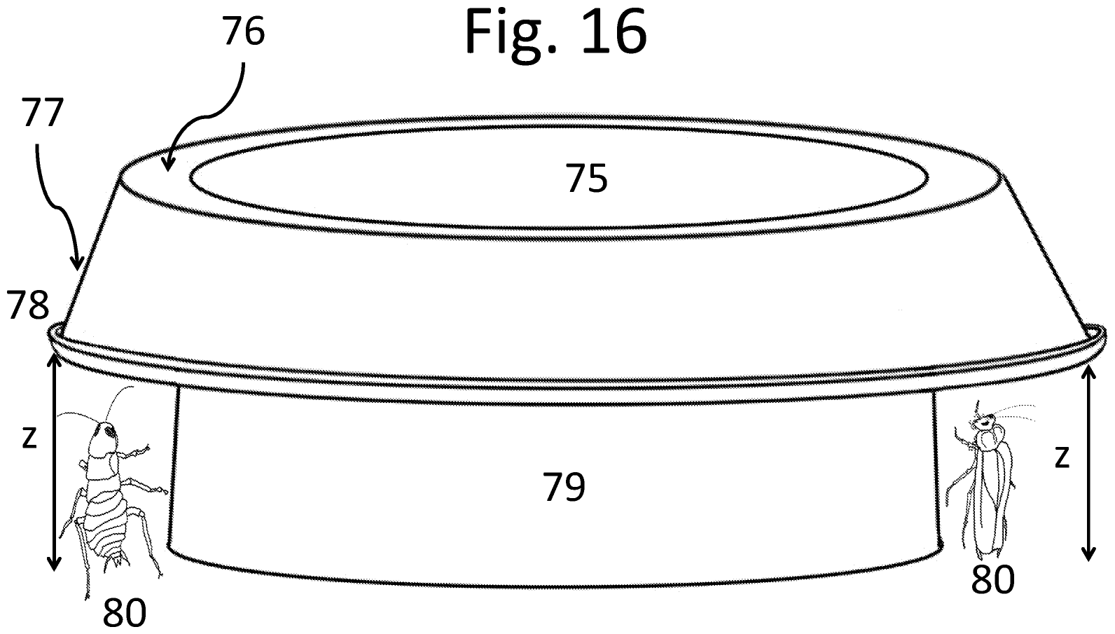

FIG. 16 is a perspective view of the same bowl device in FIG. 15 consisting of an internal container area 75, a rim 76, an anti-cockroach flange 77, a lip 78, and a generally cylindrical sidewall base support 79. The surface of the lip 78 and flange 77 need to be above the ground a distance “z” to exceed the reach of the cockroach 80.

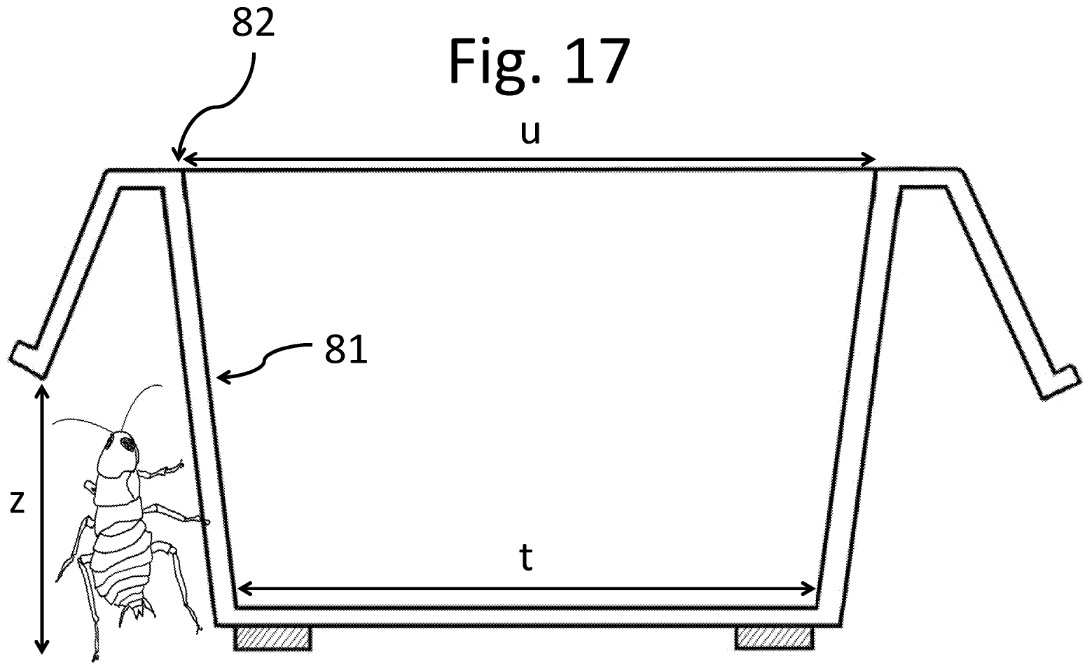

FIG. 17 is an alternative embodiment of anti-cockroach bowl that has all the same elements as shown in the embodiment of FIGS. 15 and 16 including the ant cockroach distance z excepting that the side walls 81 are angled from the superior border 82 so that the superior diameter or dimension u is greater than the inferior diameter or dimension t so that one bowl will fit into another bowl and facilitate stacking of the bowls that facilitates shipping.

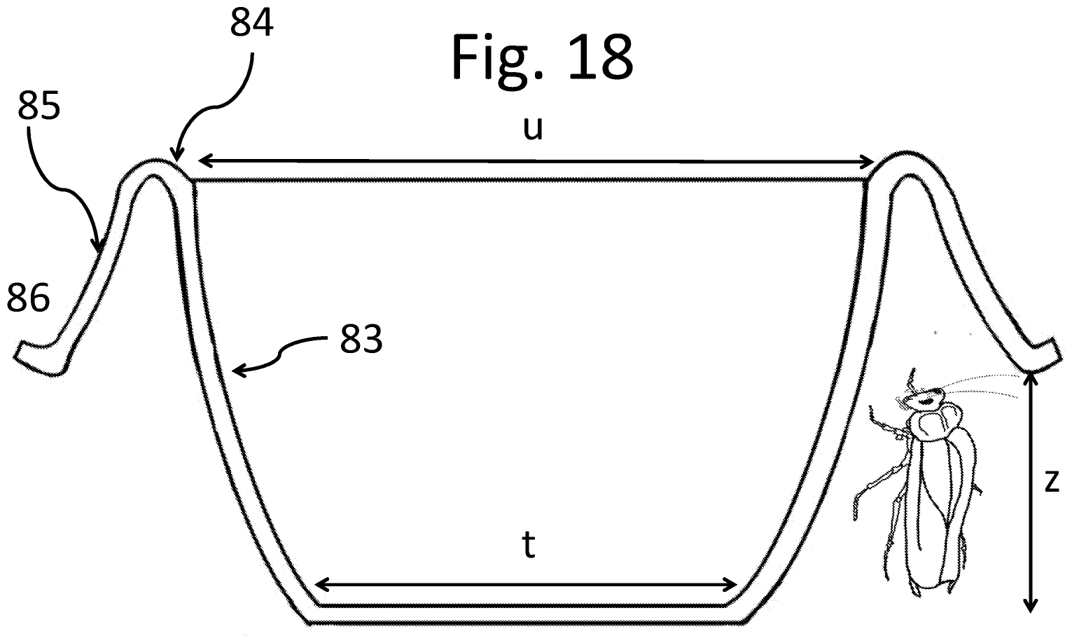

FIG. 18 is an alternative embodiment of anti-cockroach bowl that has all the same elements as shown in the embodiment of FIG. 17 including maintaining the anti-cockroach distance z excepting that the device surfaces are curved including the side walls 83, the rim 84, the anti-cockroach flange 85, and lip 86 so that the superior diameter or dimension u is greater than the inferior diameter or dimension so that one bowl will fit into another bowl and permitting stacking of the bowls a property facilitates a lower volume for shipping. These bowls with curved surfaces also facilitate shaping and mass production of the bowls from sheet metal, plastic, or polymer and freeing from the mold or stamping machine.

A potential problem with the embodiments shown in FIG. 4, FIG. 6, and FIGS. 8-9, and FIGS. 15-18 is that they have relatively narrow bases that destabilizes the bowls and permits sliding and tipping over particularly with large animals such as dogs who can move the bowls about while feeding. One solution for this instability, are bowl holders designed to maintain the anti-cockroach bowl in a fixed position.

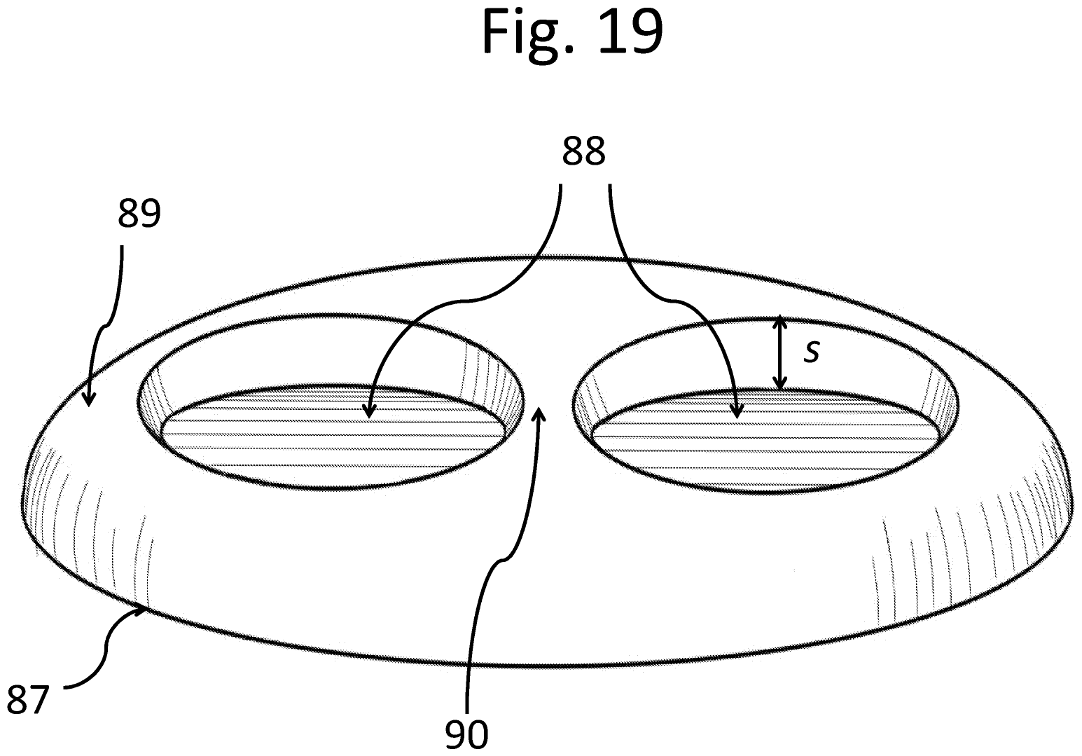

FIG. 19 is a perspective view of such an anti-cockroach bowl-holder. The bowl-holder can be elliptical in the outside edges 87 as shown or alternatively rectangular. The bowl-holder may have one or more receptacles 88 of depth s to receive an anti-cockroach bowl. FIG. 19 shows two such receptacles for reversibly receiving the anti-cockroach bowls, presumably one bowl for water and one bowl for food. However, there could one, two, or more receptacles on the holder to accommodate the desired number of bowls. The receptacles 88 have a depth s and are deep enough to receive and stabilize the inferior portion of the anti-cockroach bowl. The outlying superior surface 89 and inlying superior surface 90 are contoured away from the bowl's cockroach guard so that they minimize decreasing the anti-cockroach distance of the anti-cockroach shield on the bowl (not shown).

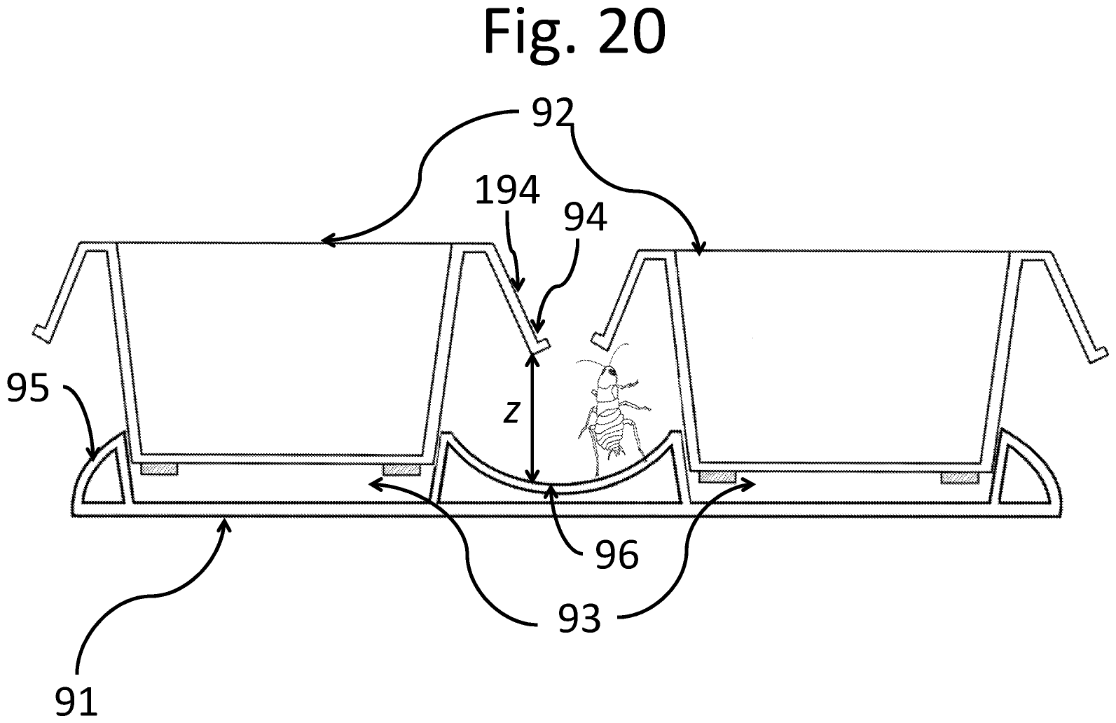

FIG. 20 is a cross-sectional view of anti-cockroach bowl-holder 91 with anti-cockroach bowls 92 seated the receptacles 93. The bowls can seat deeply flush with the bottom of the receptacles 93 or only a portion as shown. To maintain the anti-cockroach properties of the bowl the distance of the anti-cockroach flange 194 and lip 94 from the surface of the bowl-holder defined as z must maintain at least the minimum previously described effective anti-cockroach distances as shown in FIG. 5 depending on the desired effectiveness with z=0.625 inch (15.9 mm) being partially effective and z=1.75 inch (44.5 mm) and greater being 100% effective. Because of the requirement that z=be a discrete value to retain effectiveness the bowl-holder may require that certain of the surfaces such as 95 and 96 be curved or sloped to maintain a z sufficient to exclude cockroaches.

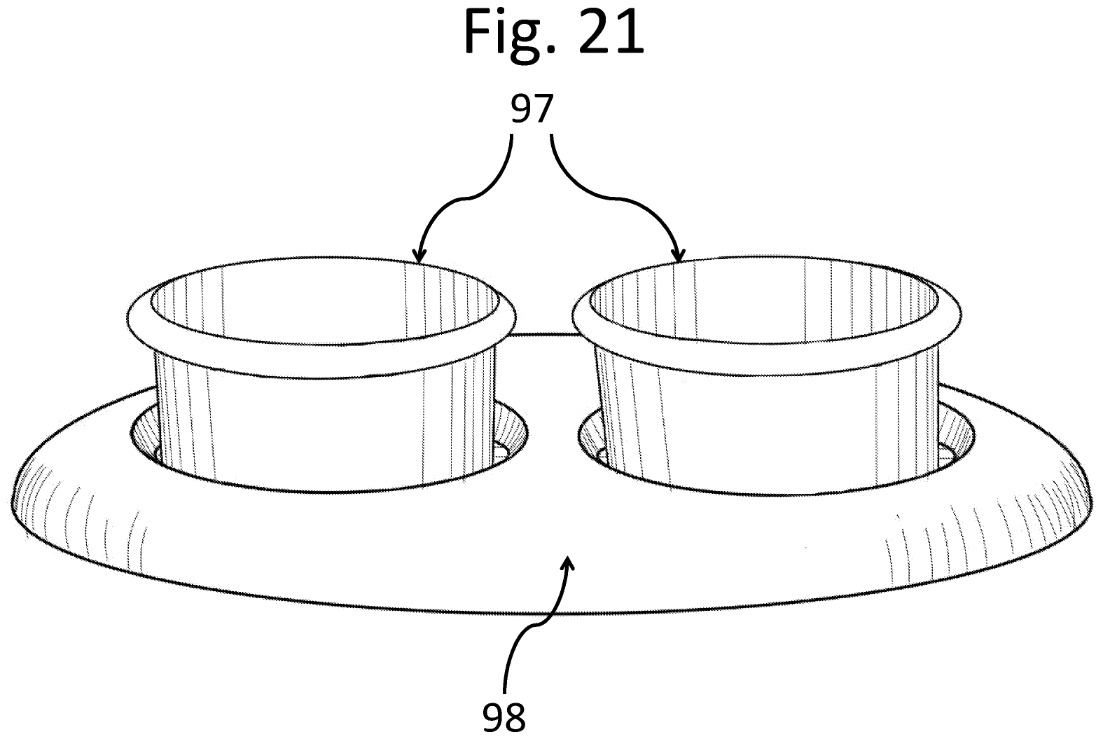

FIG. 21 is perspective view of the same bowl-holder as in FIG. 20 with the bowls 97 seated in the bowl-holder 98.

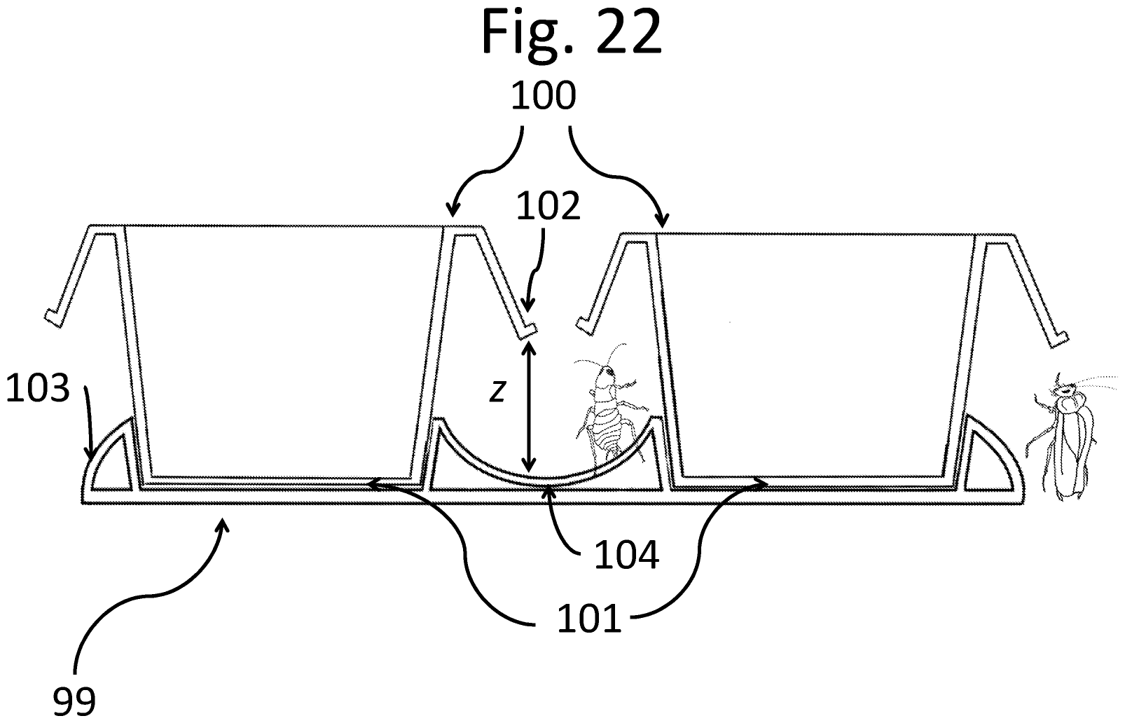

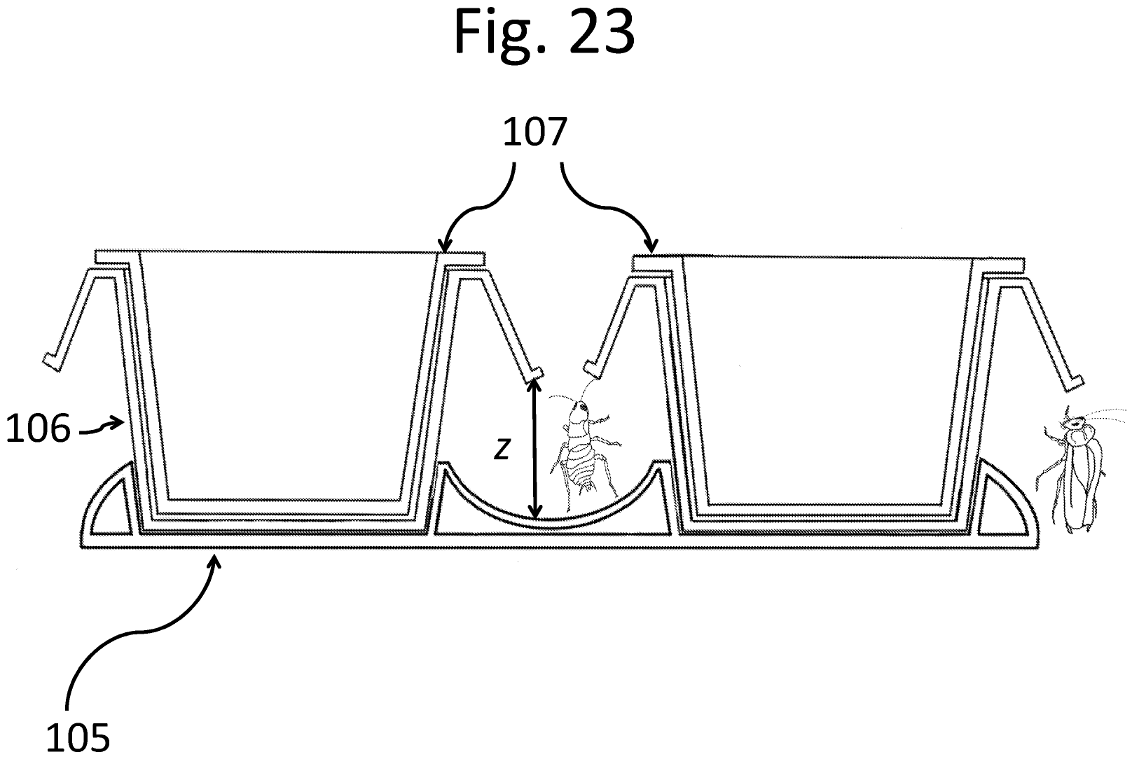

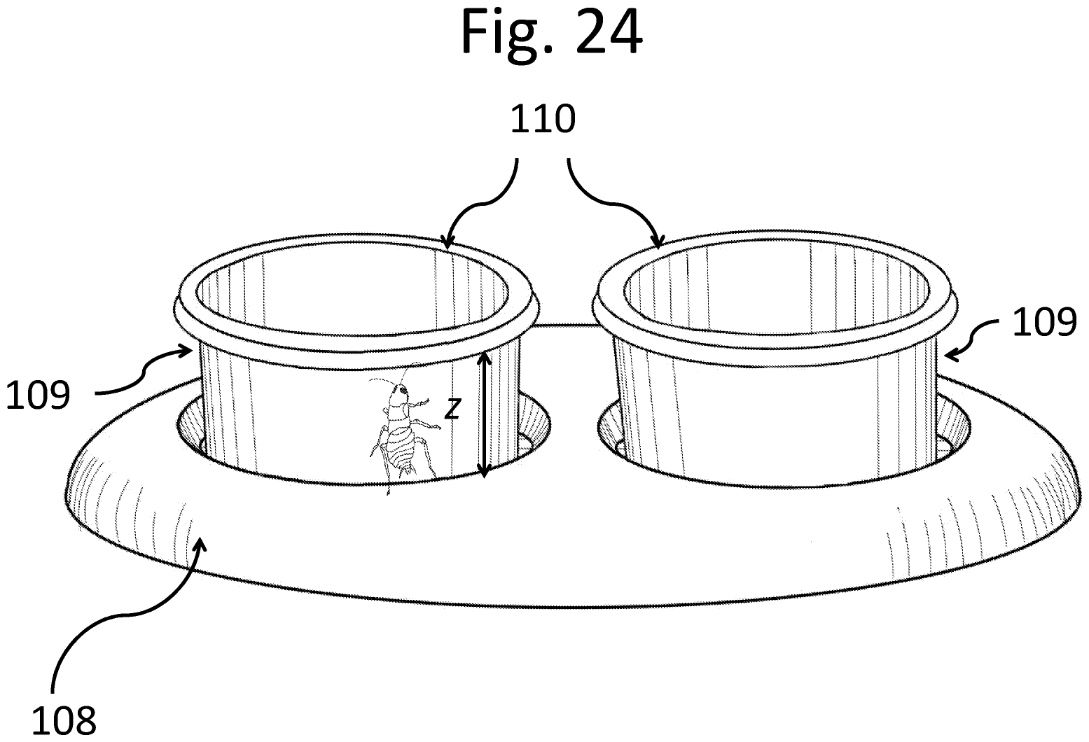

FIG. 22 is a cross-sectional view of alternative design of an anti-cockroach bowl-holder 99 with the anti-cockroach function 100 bonded to or integral to the bowl-holder 99. The anti-cockroach function 100 can be identical to the bowls shown in in FIGS. 23 and 24 but permanently anchored in, bonded, or integral 101 to the bowl-holder 99 so the anti-cockroach function is in the bowl-holder itself rather than the bowl. To maintain the anti-cockroach properties of the bowl-holder the distance of the anti-cockroach flange and lip 102 from the surface of the bowl-holder defined as z must maintain at least the minimum previously described effective anti-cockroach distances as shown in FIG. 5. Because of the requirement that z be a discrete value to retain effectiveness the bowl-holder may require that certain surfaces on the superior face of the holder 99 such as 103 and 104 be curved or sloped to maintain a z sufficient to exclude cockroaches.

FIG. 23 is a cross-sectional view of the same design as FIG. 22 of an anti-cockroach bowl-holder 105 with the anti-cockroach function 106 bonded to or integral to the bowl-holder 105 and the conventional bowel 107 without anti-cockroach properties protected by the anti-cockroach properties of the bowl-like aspect 106 of the bowl-holder 105. The distance z is maintained not by the removal bowl 107 but rather by the anti-cockroach function 106 of the cockroach holder 105.

FIG. 24 is a perspective view of the same design as FIG. 23 of an anti-cockroach bowl-holder 108 with the anti-cockroach function 109 bonded to or integral to the bowl-holder 108 and the conventional bowel 110 without anti-cockroach properties protected by the anti-cockroach properties of the bowl-like aspect 109 of the bowl-holder 108. The distance z is maintained not by the conventional bowl 110 but rather by the anti-cockroach function 109 of the cockroach holder 108.

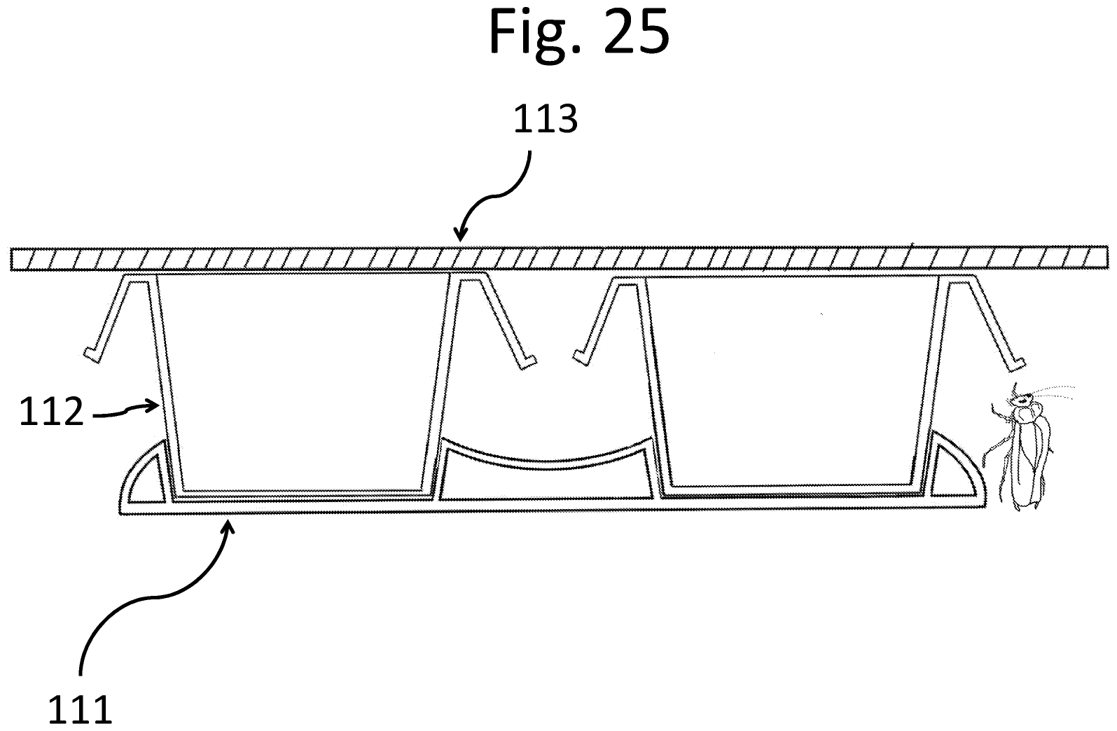

FIG. 25 is a cross-sectional view of the same design as FIG. 22 of an anti-cockroach bowl-holder 111 with the anti-cockroach function 112 bonded to or integral to the bowl-holder 111. However, instead of using the bowl-holder to hold a conventional bowl, it can be he support for a surface 113 creating an anti-cockroach table.

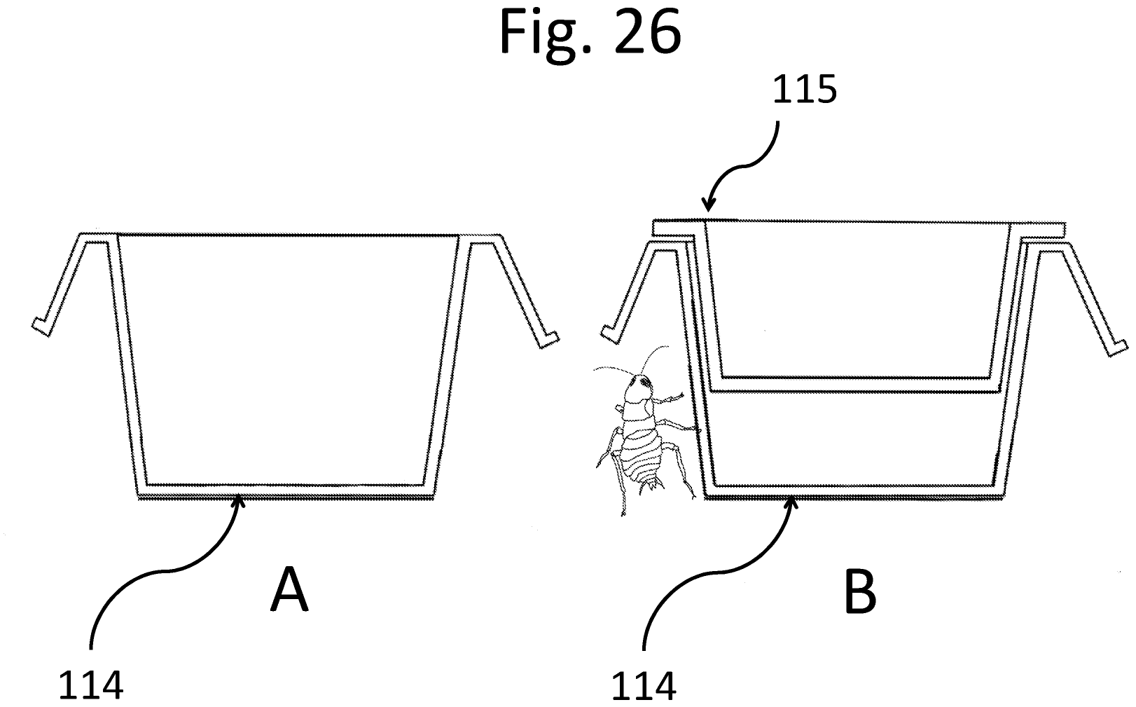

FIG. 26 A is a cross-sectional view of an anti-cockroach bowl-holder 114 with the anti-cockroach function and structure identical in all aspects to the bowl in FIG. 17 however in this case it is used an anti-cockroach bowl-holder rather than a bowl itself. It is anticipated at all of the embodiments FIG. 4, FIG. 6, and FIGS. 6-18 could be used as bowl-holders with an anti-cockroach function and a conventional bowl reversibly inserted and removed as needed. FIG. 25 B is a cross-sectional view of an anti-cockroach bowl-holder 114 with the anti-cockroach function with a conventional bowl 115 inserted into it.

It is anticipated that any of the embodiments of anti-cockroach bowl or bowl-holder could have a surface polished to make it more difficult for insects to climb and/or a surface coating applied with a low co-efficient of friction to make it more difficult for insects to climb. It is also anticipated that all the above designs would exclude ants and other crawling insects as well as cockroaches.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A cockroach resistant container comprising:
a sidewall base support (25) having an upper end connected to a rim (26) and a lower end connected to a bottom surface (24);
said sidewall base support (25) and said bottom surface define an internal container area (23);
an anti-ant shield (27) having one end connected to said rim (26) and an opposing end terminating in a lip (28);
said lip (28) located a spaced, vertical distance above said bottom surface (24); and
said vertical distance between said lip (28) and said bottom surface (24) sufficient to prevent a cockroach from accessing said lip.

2. The cockroach resistant container of claim 1 wherein said vertical distance is at least 15.9 mm.

3. The cockroach resistant container of claim 1 wherein said vertical distance is at least 25.4 mm.

4. The cockroach resistant container of claim 1 wherein said vertical distance is at least 44.5 mm.

5. The cockroach resistant container of claim 1 wherein said vertical distance is at least 57.2 mm.

6. A cockroach resistant container comprising:
a sidewall base support (25) having an upper end connected to a rim (26) and a lower end connected to a bottom surface (24);
said sidewall base support (25) and said bottom surface define an internal container area (23);
an anti-ant shield (27) having one end connected to said rim (26) and an opposing end terminating in a lip (28);
a base (30) having a bottom edge (300);
said lip (28) located a spaced, vertical distance above said bottom edge (300); and
said vertical distance between said lip (28) and said bottom edge (300) sufficient to prevent a cockroach from accessing said lip.

7. The cockroach resistant container of claim 6 wherein said vertical distance is at least 15.9 mm.

8. The cockroach resistant container of claim 6 wherein said vertical distance is at least 25.4 mm.

9. The cockroach resistant container of claim 6 wherein said vertical distance is at least 44.5 mm.

10. The cockroach resistant container of claim 6 wherein said vertical distance is at least 57.2 mm.

11. A cockroach resistant container comprising:
a bowl comprised of a sidewall base support (25) having an upper end connected to a rim (26) and a lower end connected to a bottom surface (24);
said sidewall base support (25) and said bottom surface define an internal container area (23);
an anti-ant shield (27) having one end connected to said rim (26) and an opposing end terminating in a lip (28);
a base having an outside edge defining an opening and a bottom edge;
said opening sized to receive said bowl;
said lip (28) located a spaced distance above said bottom edge; and
said vertical distance between said lip and said bottom edge sufficient to prevent a cockroach from accessing said lip.

12. The cockroach resistant container of claim 11 wherein said vertical distance is at least 15.9 mm.

13. The cockroach resistant container of claim 11 wherein said vertical distance is at least 25.4 mm.

14. The cockroach resistant container of claim 11 wherein said vertical distance is at least 44.5 mm.

15. The cockroach resistant container of claim 11 wherein said vertical distance is at least 57.2 mm.

16. The cockroach resistant container of claim 11 wherein said outside edge is sloped.

17. The cockroach resistant container of claim 11 wherein said outside edge is curved.
